(19) United States
(12) Patent Application Publication
(10) Pub. No.: US 2019/0121834 A1
(43) Pub. Date: Apr. 25, 2019

(54) COMPUTING APPARATUS AND COMPUTING METHOD

(71) Applicant: Hitachi, Ltd., Tokyo (JP)

(72) Inventor: Tatsuya TOMARU, Tokyo (JP)

(21) Appl. No.: 16/031,135

(22) Filed: Jul. 10, 2018

(30) Foreign Application Priority Data
Oct. 24, 2017 (JP) 2017-204990

(51) Int. Cl. G06F 17/11; G06N 99/00

(52) U.S. Cl. CPC G06F 17/11; G06N 99/002

(57) ABSTRACT

An object of the invention is to provide a computing technology which can operate at room temperature and have a sufficient performance for combinatorial optimization problems that need an exhaustive search. In a local-field response method in which spins being variables respond to local effective magnetic fields, a time axis is discretely treated. When spins respond to effective magnetic fields, the effective magnetic fields are determined sequentially from the site having the small magnitude of a spin, and spins respond to the fields in order. When the sign of a spin is inverted, the information is reflected in the subsequent process of determining the effective magnetic fields for other sites. Thus, a many-body effect due to quantum entanglement is phenomenologically incorporated.

### CROSS-REFERENCE TO RELATED APPLICATION

The present application claims priority from Japanese application JP 2017-204990, filed on Oct. 24, 2017, the content of which is hereby incorporated by reference into this application.

### BACKGROUND OF THE INVENTION

### 1. Field of the Invention

The present invention relates to a computing technology which is able to perform computation at a high speed with respect to combinatorial optimization problems that need an exhaustive search.

### 2. Related Art

As being representative as the word “IoT” (Internet of Things), various things are connected to the Internet in the present days; information is collected from the things; and the things are controlled by the collected information. In the control, an optimal solution is found from among many choices and is performed. Extremely speaking, the information technology in the present days can be said to search an optimal solution.

In this situation, a quantum annealing, or adiabatic quantum computing, has recently received attention. In this method, a problem is set such that the ground state of a certain physical system is a solution and the solution is obtained through finding the ground state. Let the Hamiltonian of a physical system in which a problem is set be Ĥₚ. At the beginning of computation, however, Hamiltonian is not Ĥₚ but Ĥ₀ for which the ground state is easily prepared. Next, the Hamiltonian is transformed from Ĥ₀ to Ĥₚ with a sufficient period of time. When the transformation takes a sufficient period of time, the system continues to stay in the ground state, and the ground state (solution state) for Hamiltonian Ĥₚ is finally obtained. This is a principle of the quantum annealing.

A ground state-searching method in which a physical system called Ising spin glass is used can be applicable even to a problem called NP-hard. Meanwhile, a highly difficult problem in combinatorial optimization problems belongs to the NP-hard. Moreover, problems classified into “P” and problems classified into “NP” in the computational complexity theory all can be transformed to an NP-hard problem. Therefore, if the quantum annealing is applied to the Ising spin glass system, almost all the combinatorial optimization problems can be solved, and the most important issue of the information technology is solved.

Another reason why the quantum annealing receives attention is robustness with respect to decoherence. In a quantum computer, quantum coherence must be preserved over a computing time. However, in the quantum annealing, the condition is relaxed. If the ground state is maintained, a correct solution is obtained. The quantum coherence is not necessarily to be maintained. In a current technology level, it is difficult to establish a pure quantum system. Therefore, the quantum coherence is hardly kept over the computing time. For this reason, the quantum annealing has received attention. However, there is a drawback even in the quantum annealing. The quantum annealing can only be realized in a superconducting magnetic flux qubit system as it stands, and thus, a cryogenic cooling apparatus is needed. The need for an extremely low temperature is an issue of achieving a practical computer.

To solve the issue, the local-field response method was proposed as described in the following (PTLs 1-3 and NPL 1). First, let us review the quantum annealing again. The concept of the annealing lies regardless of quantum or classical by its nature. The quantum annealing is devised to improve the performance of the classic annealing using quantum properties. The reason why the quantum annealing does not require the quantum coherence over the computing time and only requires the ground state being maintained comes from the wide concept of the annealing. As just described, the concept of the annealing is so wide that another method to use quantum properties may exist, different from the quantum annealing.

The local-field response method has been disclosed from such a point of view. In this method, similarly to the quantum annealing, a transverse field is applied to a spin system at time t=t₀, which is a computing device, and the magnetic field is gradually decreased to obtain a solution at time t=τ. The computing device itself is classical, and quantum-mechanical information is added to the response of spins to the magnetic field. The method works on a classical machine at room temperature, and therefore, it can solve the issue of cryogenic cooling in the quantum annealing. In PTLs 1-3 and NPL 1, quantum effects were introduced in the response function, where the response function which has an average quantum effect was determined empirically or based on the results solved for similar problems. In NPL 2, solution accuracy was improved compared to the methods in PTLs 1-3 and NPL 1 by phenomenologically incorporating the properties of the linear superposition in quantum mechanics. However, the property of quantum entanglement which is another important property in quantum mechanics has not been sufficiently incorporated.

### CITATION LIST

### Patent Literature

PTL 1: WO 2015/118639
PTL 2: WO 2016/157333
PTL 3: WO 2016/194221

### Non-Patent Literature

NPL 1: T. Tomaru, “Quasi-Adiabatic Quantum Computing Treated with c-Numbers Using the Local-Field Response,” J. Phys. Soc. Jpn. 85, 034802 (2016).
NPL 2: T. Tomaru, “Improved Local-field response Method Working as Quasi-Quantum Annealing,” J. Phys. Soc. Jpn. 86, 054801 (2017).

### SUMMARY OF INVENTION

### Technical Problem

As described above, the quantum annealing requires a cryogenic cooling apparatus to use a superconducting magnetic flux qubit system. Meanwhile, the local-field response method operates at room temperature, but quantum entanglement which is an important property in quantum mechanics is not sufficiently incorporated, which limits the performance. Thus, an object of the invention is to provide a computing apparatus and a computing program which can operate at room temperature and have a sufficient performance for a difficult assignment such as an issue that needs an exhaustive search.

### Solution to Problem

In a local-field response method in which spins being variables respond to local effective magnetic fields, a time axis is discretely treated; When spins respond to effective magnetic fields, the effective magnetic fields are determined sequentially from the site having the small magnitude of a spin, and the spins respond to the fields in order. When the sign of the spin is inverted, the information is reflected in the subsequent process of determining the effective magnetic fields for other sites. Thus, a many-body effect due to quantum entanglement is phenomenologically incorporated. More specific descriptions are provided in the following.

A specific figure is a computing apparatus which includes a computing unit, a storage unit, and a control unit, and performs computation under the control of the control unit while transferring data between the storage unit and the computing unit, or a computing method using the computing apparatus. N variables sⱼ^{z} (j=1, 2, . . . , N) take a range of −1≤sⱼ^{z}≤1, and an assignment is set with coefficients gⱼ indicating local terms and coefficients Jₖⱼ (k, j=1, 2, . . . , N) indicating inter-variable interactions. Time is divided into m, and the computing unit discretely performs computation from t=t₀ (t₀=0) to tₘ (tₘ≤τ). Herein, N and m are natural numbers.

Variables B_{eff,j}^{z}(tᵢ) and sⱼ^{z}(tᵢ) at each time tᵢ (i=1, 2, . . . , m) are determined in this order. B_{eff,j}^{z}(tᵢ) is a function of sₖ^{z}(tᵢ₋₁), Jₖⱼ, gⱼ, and tᵢ. sⱼ^{z}(tᵢ) is a function of B_{eff,j}^{z}(tᵢ) and tᵢ. Initial values at time t₀ are set as Bⱼ^{z}(t₀)=0 and sⱼ^{z}(t₀)=0. For determining B_{eff,j}^{z}(tᵢ) and sⱼ^{z}(tᵢ) at time tᵢ (i=1, 2, . . . , m), first, sⱼ^{z}(tᵢ₋₁) are put in descending order such that |sₘ₁^{z}(tᵢ₋₁)|≤|sₘ₂^{z}(tᵢ₋₁)|≤sₘ₃^{z}(tᵢ₋₁)|≤ . . . ≤|s_{mN}^{z}(tᵢ₋₁)|. Then, B_{eff,m1}^{z}(tᵢ) and sₘ₁^{z}(tᵢ) at site m₁ are determined at the first time, and sₘ₁^{z}(tᵢ₋₁) is set to be sₘ₁^{z}(tᵢ₋₁)=sgn(sₘ₁^{z}(tᵢ))|sₘ₁^{z}(tᵢ₋₁)|. Next, B_{eff,m2}^{z}(tᵢ) and sₘ₂^{z}(tᵢ) at site m₂ are determined and sₘ₂^{z}(tᵢ₋₁) is set to be sₘ₂^{z}(tᵢ₋₁)=sgn(sₘ₂^{z}(tᵢ))|sₘ₂^{z}(tᵢ₋₁)|. The computation at site m₃ is performed similarly, and the computation up to site m_{N} is performed similarly for the computation at time tᵢ. As the time step progresses from t=t₀ to t=tₘ, the variable sⱼ^{z} approaches −1 or 1, and a solution is determined as sⱼ^{zfd}=−1 if sⱼ^{z}<0 and as sⱼ^{zfd}=1 if sⱼ^{z}>0.

As described, the same computation has been performed up to the site m_{N} for the computation at time tᵢ, but there is an option that the same computation is performed up to mₓ (herein, 0<x≤N), and that after site mₓ all remaining sites are processed in an individual and parallel manner similarly to the original local-field response method for the computation at time tᵢ. Here, x is a natural number.

### Advantageous Effects of Invention

The present method operates on a classical machine. Extremely low temperature is not needed. In addition, there is no need to take quantum coherence into consideration. As a result, usable resources are expanded, and electric circuits can also be used. Moreover, solution accuracy is improved and a computation time is shortened through phenomenologically incorporating the effect of quantum entanglement. Thanks to these properties, it is possible to realize a practical computing apparatus which can solve difficult problems with high solution accuracy.

### BRIEF DESCRIPTION OF DRAWINGS

FIG. 1 is a diagram schematically illustrating a principle of an embodiment;

FIG. 2 is a flowchart illustrating an example of an algorithm in accordance with the first embodiment;

FIG. 3 is a graph plotting specific values of the response function r_{b};

FIG. 4 is a flowchart illustrating an example of an algorithm in accordance with the second embodiment;

FIG. 5 is a flowchart illustrating an example of an algorithm in accordance with the third embodiment;

FIG. 6 is a flowchart illustrating another example of the algorithm in accordance with the third embodiment;

FIG. 7 is a flowchart illustrating an example of an algorithm in accordance with the fourth embodiment;

FIG. 8 is a flowchart illustrating an example of an algorithm in accordance with the fifth embodiment;

FIG. 9 is a diagram illustrating an example of an algorithm in accordance with the sixth embodiment; and

FIG. 10 is a block diagram illustrating an example of a configuration of a computing apparatus in accordance with the seventh embodiment.

### DESCRIPTION OF EMBODIMENTS

Embodiments will be described in detail using the drawings. However, the content of the embodiments described below is not interpreted in a way of limiting the invention. A person skilled in the art can easily understand that the specific configuration may vary in a scope not departing from the idea and the spirit of the invention.

Portions having the same or similar functions in the configuration of the invention described below will be represented with the same symbol and commonly used in different drawings, and the redundant description will be omitted.

In a case where there are elements having similar or corresponding functions, the elements may be attached to the same symbol with different suffixes. However, in a case where there is no need to distinguish plural elements, the suffixes may be omitted.

### First Embodiment

In the first embodiment, we will give the basic principle, starting from a quantum-mechanical description and transforming it into a classical form.

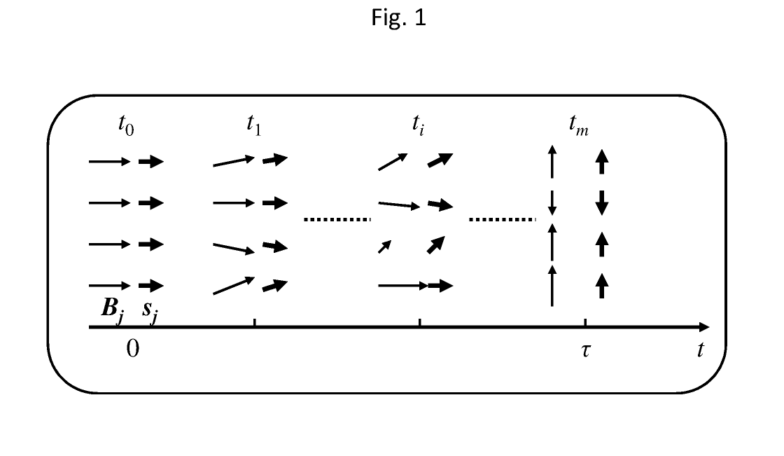

FIG. 1 schematically show the principle of the embodiment. A basic framework is the same as the local-field response method disclosed in PTL 1 and NPL 1. A transverse field is applied at t=0 to make spins directed in one direction. Thereafter, the transverse field is gradually decreased, and Hamiltonian is set to the problem Hamiltonian at t=τ. Spins time-evolve in response to the local effective magnetic field which is applied to each spin at each time.

Let the problem Hamiltonian and the Hamiltonian at t=0 be Eqs. (1) and (2), respectively.

$$\begin{matrix}{\hat{H}}_{p} = - {\sum }_{i > j} {J}_{ij} {\hat{σ}}_{i}^{z} {\hat{σ}}_{j}^{z} - {\sum }_{j} {g}_{j} {\hat{σ}}_{j}^{z} & ( 1 ) \\ {\hat{H}}_{0} = - γ {\sum }_{j} {\hat{σ}}_{j}^{z} & ( 2 )\end{matrix}$$

Let the Hamiltonian at time t be Eq. (3).

$$\hat{H} ( t ) = ( 1 - \frac{t}{τ} ) {\hat{H}}_{0} + \frac{t}{τ} {\hat{H}}_{p} \qquad ( 3 )$$

Herein, τ is a computation time. From an analogy with a one-spin system, the effective magnetic field at site j is given by B̂_{eff,j}=−∂Ĥ/∂σ̂ⱼ.

$${\hat{B}}_{eff , j} ( t ) = ( ( 1 - \frac{t}{τ} ) γ , 0 , \frac{t}{τ} ( {\sum }_{k ( \neq j )} {J}_{kj} {\hat{σ}}_{k}^{z} + {g}_{j} ) ) \qquad ( 4 )$$

The local-field response method of this embodiment operates on a classical machine in which expectation value <σ̂ⱼ> is regarded as a spin variable. As seen in Eqs. (1) and (2), <σ̂ⱼ> and <B̂_{eff,j}> consists of only x and z components. Therefore, a response function r_{b}(t) is defined only by the x and z components as described by Eq. (5).

[symbol]

\hat{σ}ⱼ^{z}(t) [symbol] / [symbol] \hat{σ}ⱼ^{x}(t) [symbol] =r_{b}(t)· [symbol] \hat{B}_{eff,j}^{z}(t) [symbol] / [symbol] \hat{B}_{eff,j}^{x}(t) [symbol] (5)

A spin direction is determined based on the response function. When the spin system is classical, the response of each spin is determined only by the effective magnetic field at each site, and the response function is r_{b}(t)=1.

However, there is a non-local correlation (quantum entanglement) in quantum mechanics, and generally r_{b}(t)≠1. As mentioned already, Eq. (5) has been transformed to a classic form by taking the expectation value, but a quantum effect is incorporated in r_{b}(t)≠1. A value of r_{b}(t) is determined empirically or through quantum-mechanical prior calculations for similar problems. The quantum effect herein is an average one because it is empirically determined or it is based on the results for similar problems. The local-field response method can incorporate quantum effects through various methods. The method through r_{b}(t)≠1 is an example. Note that setting r_{b}(t)=1 without the quantum effect is also allowed in the local-field response method. The local-field response method itself can operate even when the quantum effect is not incorporated.

Four variables <σ̂ⱼ^{z}(tᵢ)>, <σ̂ⱼ^{x}(tᵢ)>, <B̂_{eff,j}^{z}(tᵢ)>, and <B̂_{eff,j}^{x}(tᵢ)> in Eq. (5) are expectation values, and therefore, classical quantities. For this reason, let us change the quantum-mechanical description to a classical-physics one, i.e., <σ̂ⱼ^{x}(tᵢ)>→sⱼ^{x}(tᵢ), <σ̂ⱼ^{z}(tᵢ)>→sⱼ^{z}(tᵢ), <B̂_{eff,j}^{x}(tᵢ)>→B_{eff,j}^{x}(tᵢ), <B̂_{eff,j}^{z}(tᵢ)>→B_{eff,j}^{z}(tᵢ). With the description change, Eq. (5) is modified to Eq. (6).

(sⱼ^{z}(t)/sⱼ^{x}(t))=r_{b}(t)·(B_{eff,j}^{z}(t)/B_{eff,j}^{x}(t)) (6)

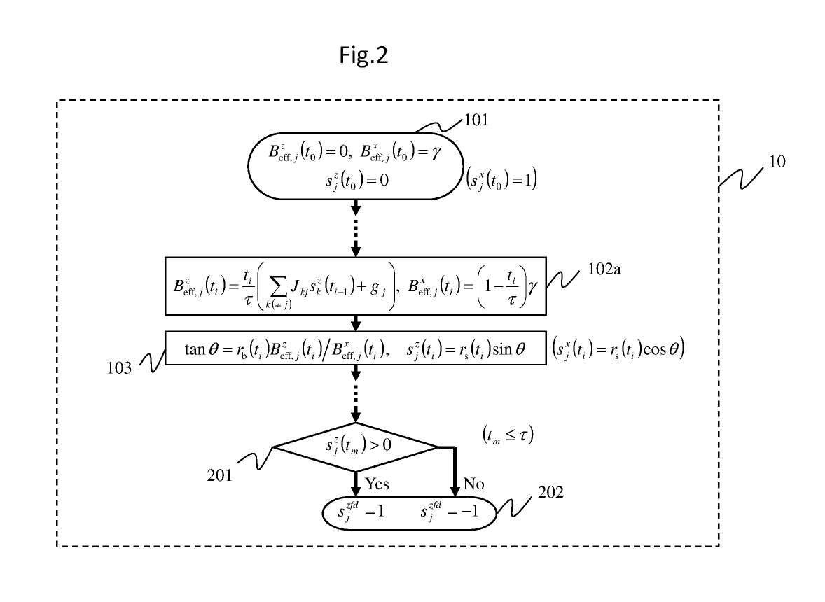

The time-evolution in the local-field response method is discrete. B_{eff,j}^{z}(tᵢ) at time tᵢ is determined from sₖ^{z}(tᵢ₋₁) at time tᵢ₋₁ in accordance with Eq. (4). sⱼ^{z}(tᵢ) at time tᵢ is determined from B_{eff,j}^{z}(tᵢ) at time tᵢ in accordance with Eq. (6). This procedure is repeated. FIG. 2 summarizes the procedure as a flowchart.

Step 101 in FIG. 2 indicates a start point of the algorithm and sets initial values. Step 102a determines B_{eff,j}^{z}(tᵢ) using sₖ^{z}(tᵢ₋₁) at time tᵢ₋₁, and determines the transverse field intensity B_{eff,j}^{x}(tᵢ) depending on time. Step 103 determines tan θ=r_{b}(t)·B_{eff,j}^{z}(tᵢ)/B_{eff,j}^{x}(tᵢ) corresponding to the spin direction using B_{eff,j}^{z}(tᵢ)/B_{eff,j}^{x}(tᵢ) and the response function r_{b}(t), and it determines sⱼ^{z}(tᵢ)=rₛ(t)·sin θ using a parameter rₛ(t) representing the magnitude of the spin. rₛ(t) is defined by rₛ(t)²=sⱼ^{x}(tᵢ)²=sⱼ^{z}(tᵢ)², and it is determined empirically or through prior calculations similarly to r_{b}(t). A specific example will be described in the following second paragraph. Steps 102a and 103 in FIG. 2 are a set of repeated computation. The set is repeated until t=tₘ (≤τ). At t=tₘ, a solution sⱼ^{zfd} is determined as sⱼ^{zfd}=1 if sⱼ^{z}(t)>0 and sⱼ^{zfd}=−1 if sⱼ^{z}(tₘ)<0 (Steps 201 and 202). Herein, the reason why tₘ≤τ is assumed is that many cases obtain converged solutions before t=τ in the time-evolution.

Step 103 can be generally written using a function f such as sⱼ^{z}(tᵢ)=f(B_{eff,j}^{z}(tᵢ), tᵢ), and f(B_{eff,j}^{z}(tᵢ), tᵢ)=rₛ(t)·sin{arctan(r_{b}(t)·B_{eff,j}^{z}(tₖ)/B_{eff,j}^{x}(tₖ))}. rₛ(t) is a parameter expressing the magnitude of the spin and satisfies 0≤rₛ(t)≤1. Thus, −1≤sⱼ^{z}(tᵢ)≤1. Here, when r_{b}(t)=1 and rₛ(t)=1, then the system is purely classical.

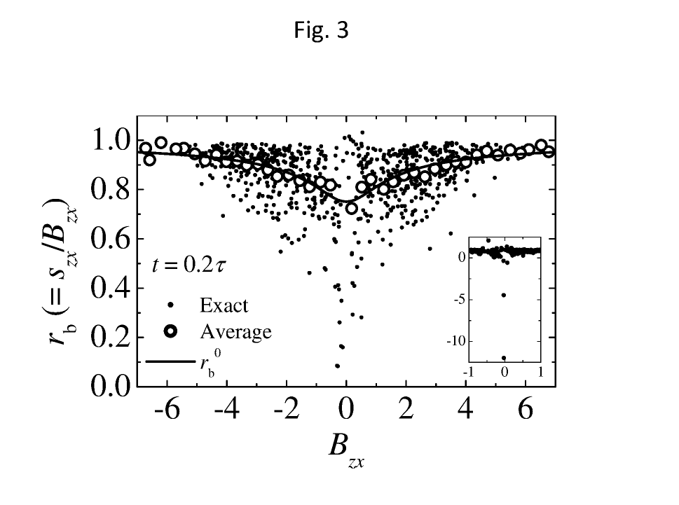

FIG. 3 shows an example of prior computations for the response function r_{b}(t). The example shows a case where Jᵢⱼ and gⱼ are determined by uniform random numbers of [−5, 5] in an 8-bit system. The figure shows the results of 100 problems and contains 800 points (100 problems×8 bits). Here, B_{zx}≡<B̂_{eff,j}^{z}>/<B̂_{eff,j}^{x}> and s_{zx}≡<σ̂ⱼ^{z}>/<σ̂ⱼ^{x}>. The points indicate values computed exactly quantum-mechanically. The response functions largely scatter owing to the non-local correlation in quantum mechanics. Open circles indicate average values, where the horizontal axis is divided into 40 regions and the points in each region are averaged. The averaged response function has smooth dependence on B_{zx}. Because being smooth, the response function can be expressed with several parameters. NPL 1 discloses a technique of expressing the smooth response function using four parameters. A solid line r_{b}⁰(t) in FIG. 3 is obtained with the technique. Another parameter rₛ(t) is also obtained from the same four parameters.

Hitherto, an example of the response function has been described in FIG. 3, and a method of determining r_{b}⁰(t) and rₛ(t) has been described with reference to NPL 1. However, the method of determining the response functions r_{b}⁰(t) and rₛ(t) is not limited to the above description, and various methods may be employed and the response functions can also be empirically determined. In the following embodiment, r_{b}⁰(t) is not limited to the solid line in FIG. 3, but assumed to be a response function in which quantum effects are incorporated on average.

Here, similarly to r_{b}(t), rₛ(t) is also possible to set rₛ(t)=1. While the range of r_{b}(t) is −∞<r_{b}(t)<∞, rₛ(t) is 0≤rₛ(t)≤1. Therefore, the influence of assuming rₛ(t)=1 on a final solution is smaller than that of assuming r_{b}(t)=1. Thus, it is effective to set rₛ(t)=1 when prior information for determining rₛ(t) is insufficient.

### Second Embodiment

The first embodiment has been described that quantum effects can be averagely incorporated through r_{b}(t)≠1. However, quantum effects depend on problems and vary with time. Quantum effects cannot be sufficiently incorporated only through averaged quantities. This embodiment describes a method of phenomenologically incorporating a quantum entanglement related-quantum effect in the formulation depending on the spin state at each time.

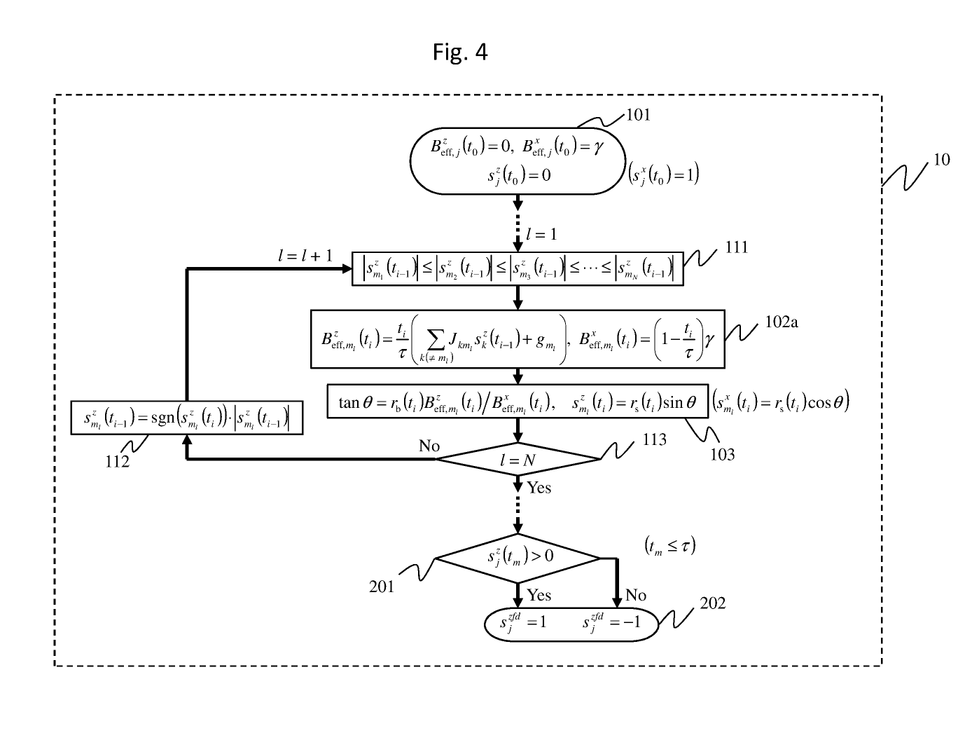

The influence of quantum entanglement appears as a many-body effect. When quantum entanglement is large, if a certain spin is inverted (its sign is inverted), another spin is simultaneously inverted with high probability. In the algorithm of FIG. 2, the effective magnetic field B_{eff,j}^{z}(tᵢ) at t=tᵢ is calculated site by site using sⱼ^{z}(tᵢ₋₁) at t=tᵢ₋₁. The calculation is performed independently site by site and it is in a one-body approximation. Therefore, simultaneous inversion of spins has not been sufficiently taken into consideration. For this reason, we take simultaneous inversion of spins into consideration in accordance with the algorithm in FIG. 4.

In the vicinity of the spin inversion, sⱼ^{z}≈0. Therefore, the spin that has a smaller value of |sⱼ^{z}| has higher probability of inversion. Thus, let us first put |sⱼ^{z}(tᵢ₋₁)| at each time tᵢ₋₁ in descending order.

Let m₁, m₂, m₃, . . . be the site number of |sⱼ^{z}(tᵢ₋₁)| in the descendent order as illustrated in Step 111 in FIG. 4. B_{eff,m1}^{z}(tᵢ) at site m₁ is calculated using Eq. (4) (Step 102a), and sₘ₁^{z}(tᵢ) is calculated using Eq. (6) (Step 103). If there is no sign inversion in the time evolution from sₘ₁^{z}(tᵢ₋₁) to sₘ₁^{z}(tᵢ), the next procedure is to compute B_{eff,m2}^{z}(tᵢ) and sₘ₂^{z}(tᵢ) at site m₂. If the sign is inverted, sₘ₁^{z}(tᵢ₋₁) is changed to −sₘ₁^{z}(tᵢ₋₁), and after that, B_{eff,m2}^{z}(tᵢ) and sₘ₂^{z}(tᵢ) are computed. In other words, the sign of sₘ₁^{z}(tᵢ₋₁) is changed into the sign of sₘ₁^{z}(tᵢ) as sₘ₁^{z}(tᵢ₋₁₎→sgn(sₘ₁^{z}(tᵢ))·|sₘ₁^{z}(t₁₋₁)| (Step 112). Here, sgn denotes a sign function which returns 1 or −1 in accordance with the sign of the argument.

According to this procedure, the change for site m₁ at time tᵢ is immediately reflected on the time evolution for site m₂. When sites m₁ and m₂ are entangled, if the spin at site m₁ is inverted, the spin at site m₂ is inverted with high probability. Such an effect is incorporated as the change of the sign described herein. In other words, the effect of quantum entanglement is incorporated phenomenologically.

The computed result of sₘ₂^{z}(tᵢ) is also processed similarly to sₘ₁^{z}(tᵢ) i.e., sₘ₂^{z}(tᵢ₋₁)→sgn(sₘ₂^{z}(tᵢ))·|sₘ₂^{z}(tᵢ₋₁)| (Step 112). By repeating the similar process for site m₃ and the following sites, we obtain N components of sⱼ^{z}(tᵢ) (Step 113), and the process at time tᵢ is completed.

Once the process at time tᵢ is completed, the next procedure is the process at time tᵢ₊₁, and the similar processes are repeated until time t=tₘ≤τ to obtain the final solution. The final solution is sⱼ^{zfd}=1 if sⱼ^{z}(tₘ)>0 and sⱼ^{zfd}=−1 if sⱼ^{z}(tₘ)<0 similarly to the case of the first embodiment (Steps 201 and 202).

The spin inversion is connected to a tunneling phenomenon in a viewpoint of quantum mechanics. According to this interpretation, the treatment in this embodiment is said to take multiple tunneling into consideration.

The energy value for the obtained solution is given by Eq. (7).

$${H}_{p} ( {t}_{i} ) = - {\sum }_{k > j} {J}_{kj} {s}_{k}^{zfd} ( {t}_{i} ) {s}_{j}^{zfd} ( {t}_{i} ) - {\sum }_{j} {g}_{j} {s}_{j}^{zfd} ( {t}_{i} ) \qquad ( 7 )$$

The local-field response method operates similarly to quantum annealing. The spin system in which the ground state is prepared at t=0 time-evolves and comes to the ground state of the problem-embedded system at t=τ ideally. The convergence of solutions is high according to the method of this embodiment. The lowest energy state during the computation is the state at t=tₘ with high probability (the ground state with high probability). However, in the method of the first embodiment, the convergence of the solution is low, and the lowest energy state might be the state at t<tₘ. When the first embodiment is used, the energy needs to be calculated at each time using Eq. (7) and the state corresponding to the lowest energy needs to be selected as the final solution. The amount of computation for that purpose is O(N²) for the first term in Eq. (7) and O(N) for the second term (here, O is the Landau symbol). The sum of both terms are summarized to O(N²). In contrast, if the method of this embodiment is used, because the convergence of the solution is high, the energy does not need to be calculated, and the amount O(N²) of computation can be saved.

On the other hand, the method of this embodiment rearranges the spins in Step 111. The amount of the processing is estimated as follows. If each spin is simply compared with the other spins in a repeated manner, the amount is O(N²). This is the upper limit for the processing. The lower limit is estimated as follows. Let us consider that an array of spins has already put in the descending order, and that only the adjacent spins are compared and exchanged. If there is no exchanging, the amount of computation is O(N) because each spin is compared with only one side of adjacent spins. Because a huge number of exchanges is generally rare, the actual amount of computation approaches O(N). Thus, the overhead of this embodiment is about O(N), which is smaller than the overhead O(N²) of the first embodiment.

The amount of computation for the entire local-field response method is dominated by the computation of the effective magnetic field in Step 102a. Because every N site amounts to O(N), the total amount is O(N²). Therefore, the overhead O(N) in this embodiment is negligible in a system in which N is sufficiently large.

As described above, in the example of FIG. 2, Steps 102a and 103 are processed independently and in parallel for all sites. For this reason, although the processing speed is high, quantum entanglement is not sufficiently taken into consideration. In contrast, in the example of FIG. 4 in this embodiment, the effect of quantum entanglement is phenomenologically incorporated through adding Steps 112 and 111, which makes the influence of the other spins for the relevant spin at the moment reflect at steps 102a and 103. As a result, solution accuracy is improved; the convergence of the solution is improved; and the computation time can be saved.

### Third Embodiment

Quantum-mechanically, the effective magnetic field is determined based on Eq. (4). An eigenvalue of σ̂ₖ^{z} is ±1. However, because the local-field response method operates such that a spin variable sₖ^{z} takes an expectation value <σ̂ₖ^{z}>, |sₖ^{z}|≤1 is satisfied. For this reason, the term Σ_{k(≠j)}Jₖⱼsₖ^{z} is generally underestimated compared with gⱼ.

If the computation is performed while the term of Σ_{k(≠j)}Jₖⱼsₖ^{z} is underestimated, the solution accuracy is degraded. Therefore, the value of gⱼ is normalized with reference to the value of sₖ^{z}. A factor cᵢ=(Σₖsₖ^{z}(tᵢ₋₁)²/N)^{1/2} is multiplied to gⱼ to obtain gⱼ^{norm}(tᵢ)=cᵢgⱼ. If gⱼ^{norm}(tᵢ) is set as a local term, the contributions of the terms gⱼ^{norm}(tᵢ) and Σ_{k(≠j)}Jₖⱼsₖ^{z} are almost equal, and the solution accuracy is improved. Here, let m (tₘ≤τ) be the number of divisions in the discrete time axis, and c₁ is set as about c₁=1/m. If c₁ is simply determined in accordance with cᵢ=(Σₖsₖ^{z}(tᵢ₋₁)²/N)^{1/2} and sₖ^{z}(t₀)=0, then c₁=0. The setting of c₁=1/m is to cope with c₁=0.

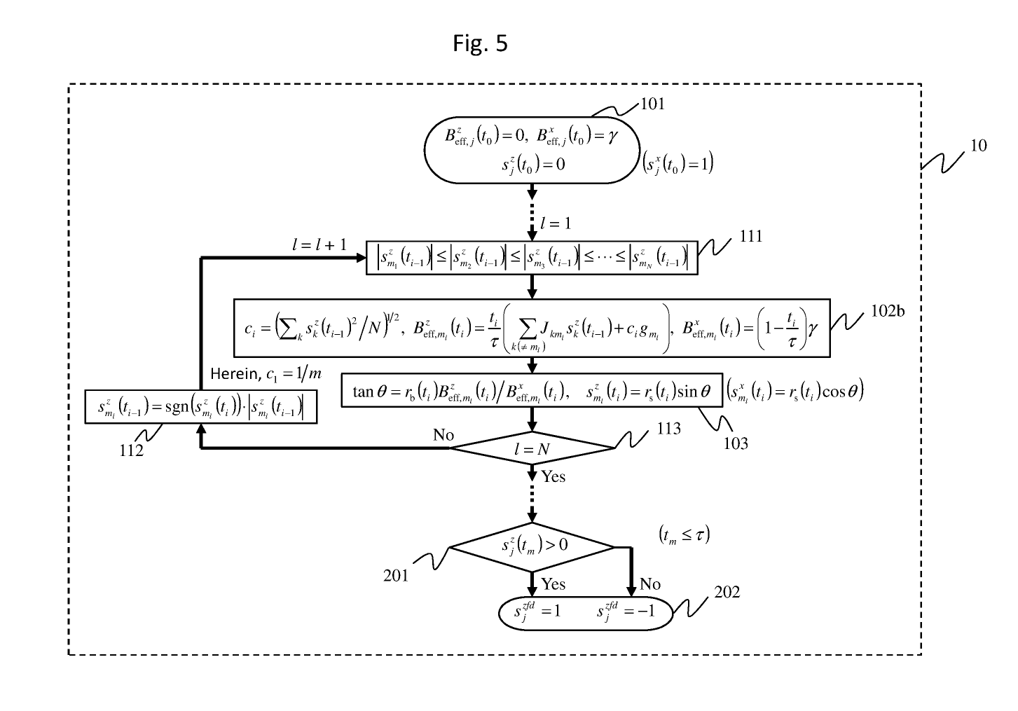

FIG. 5 illustrates a flowchart containing the above processes. A difference from FIG. 4 is that Step 102a is replaced with Step 102b. In Step 102b, the process about the factor cᵢ=(Σₖsₖ^{z}(tᵢ₋₁)²/N)^{1/2} is added.

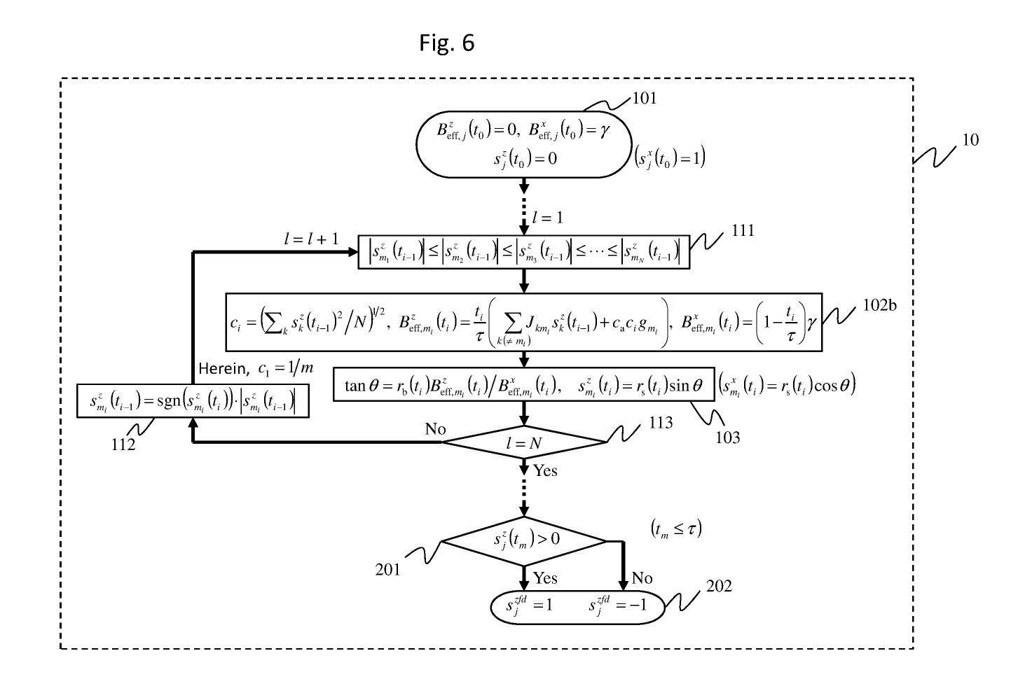

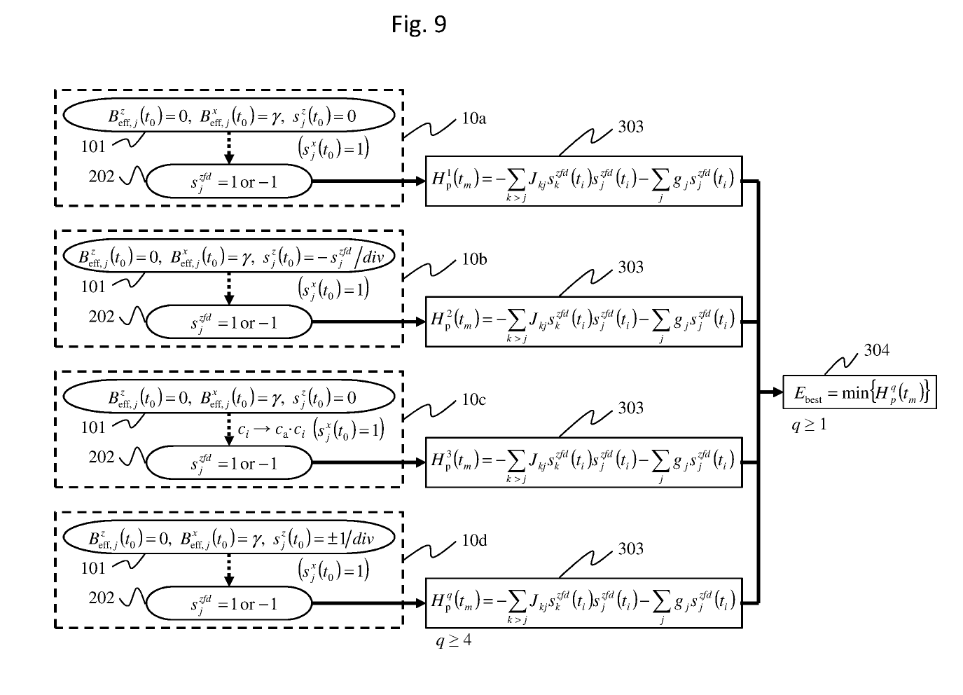

FIG. 6 illustrates a modification. If a parameter cₐ is introduced and the factor cᵢ is set as cₐ·cᵢ, the magnitude of the factor cᵢ can be adjustable. FIG. 6 is such a case. As described below, the factor cᵢ in Step 10c in FIG. 9 is also replaced with cₐ·cᵢ. The value of cₐ is empirically determined, and is about 1 to 50.

### Fourth Embodiment

In quantum-mechanical spin systems, the spins always affect other spins with each other. That is, spin σ̂ⱼ^{z} at a site j affects spine σ̂ₖ^{z} at another site k, and inversely σ̂ₖ^{z} affects σ̂ⱼ^{z}. Therefore, the spin σ̂ⱼ^{z} affects itself through the spin σ̂ₖ^{z} at site k. That is the reason why, in quantum mechanics, the state of a spin depends not only on the state of other spins interacting with the relevant spin but also on the state of itself. A magnitude of the influence on itself through the interaction is proportional to Σ_{k(≠j)}Jₖⱼ². The first embodiment has described the averaged quantum effect. Because Σ_{k(≠j)}Jₖⱼ² are squared terms, they are left even after averaged. That is the reason why the averaged response function becomes r_{b}⁰(t)≠1. The open circles and the solid line in FIG. 3 show such a behavior. A detailed theory about Σ_{k(≠j)}Jₖⱼ² is disclosed in NPL 2.

Terms Σ_{k(≠j)}Jₖⱼ² that are the origin of r_{b}⁰(t)≠1 contain information Jₖⱼ for each problem. If the information is usable, the computation becomes more accurate. Thus, we replace the averaged response function r_{b}⁰(t) with r_{b}⁰_{mod}(t), where r_{b}⁰_{mod}(t) is defined by 1−r_{b}⁰_{mod}(t)=(1−r_{b}⁰(t))Σ_{k(≠j)}Jₖⱼ²/Σ_{k(≠j)}ave(Jₖⱼ²). Herein, ave(Jₖⱼ²) is the average of Jₖⱼ² which are used to determine r_{b}⁰(t). With the improvement, the response function reflects an actual problem, and the solution accuracy increases.

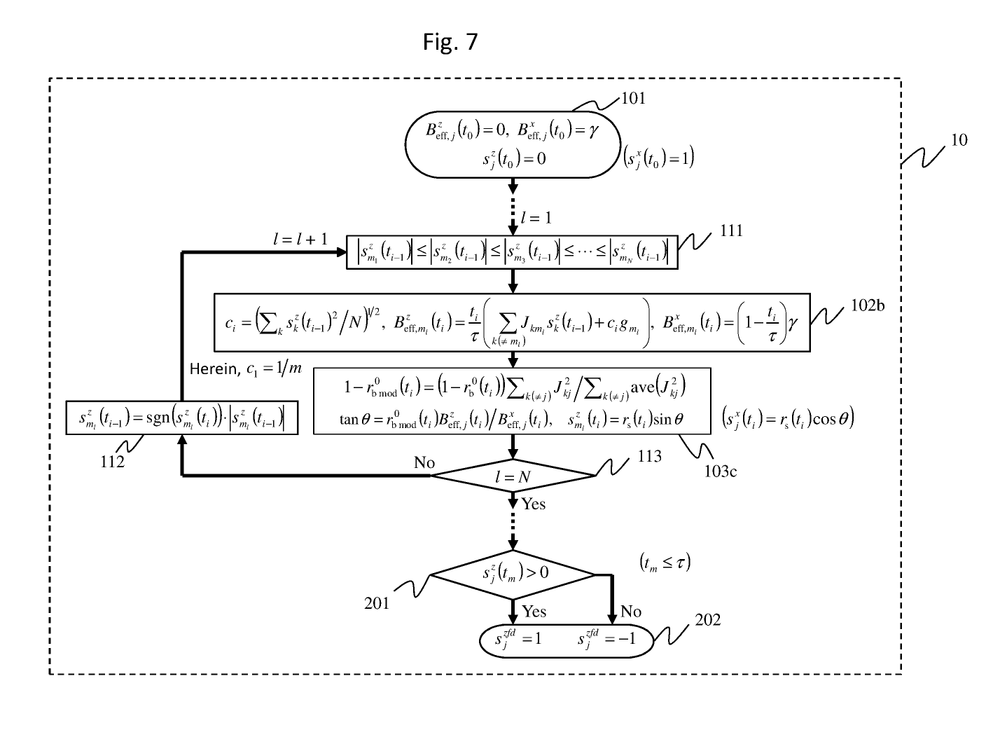

FIG. 7 illustrates a flowchart containing the above processes. A difference from FIG. 5 is that Step 103 is replaced with Step 103c.

### Fifth Embodiment

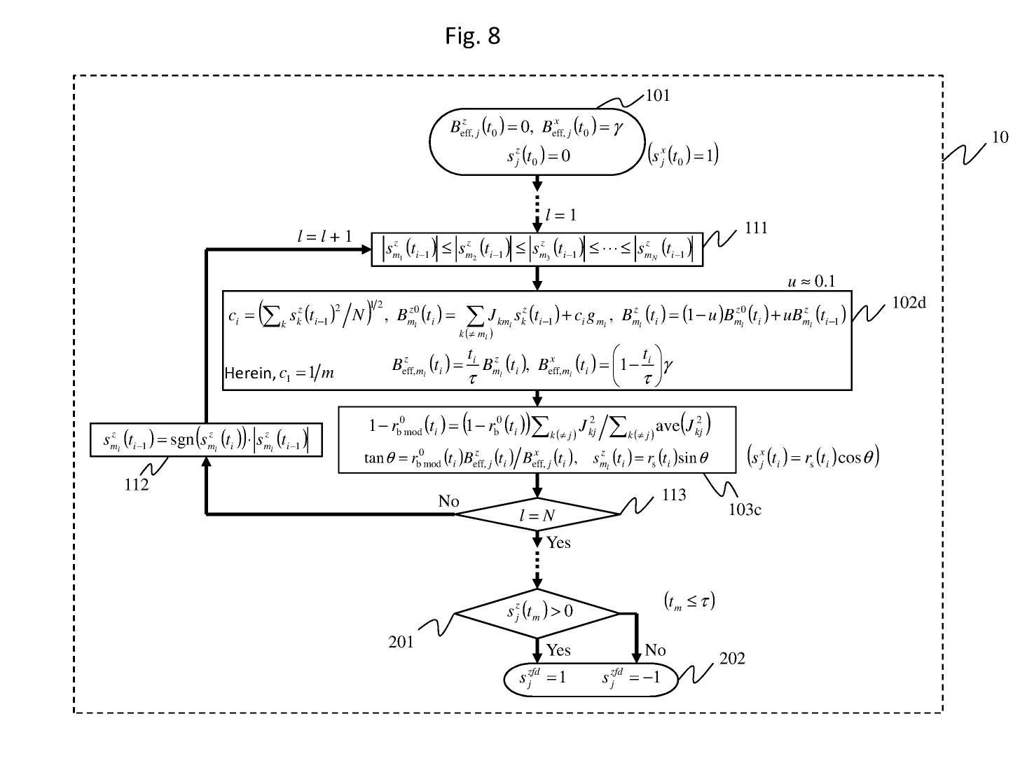

Quantum entanglement and linear superposition are representative characteristic natures in quantum mechanics. The effect of the former quantum entanglement has been phenomenologically incorporated in up to the fourth embodiment. The effect of the latter linear superposition is phenomenologically incorporated in NPL 2. In this embodiment, the both effects are incorporated at the same time. FIG. 8 illustrates such a case.

In the embodiment illustrated in FIG. 8, the difference from FIG. 7 is that Step 102b is replaced with Step 102d.

The characteristic of linear superposition is prominent in a time region where the sign of a spin changes.

Quantum-mechanically, bands anti-cross in the vicinity of that region, and the state is linear superposition there. As a result, sⱼ^{z}(t)≈0, and correspondingly B_{eff,j}^{z}(t)≈0. In order to phenomenologically incorporate the effect, the effective magnetic fields at times tᵢ and tᵢ₋₁ are linearly combined to give the effective magnetic field B_{eff,j}^{z}(tᵢ) at t=tᵢ. Specifically, Bⱼ^{z0}(tᵢ) defined by Eq. (8) is first determined using the spin values sⱼ^{z}(tᵢ₋₁) at time tᵢ₋₁.

$${B}_{j}^{z 0} ( {t}_{i} ) = {\sum }_{k ( \neq j )} {J}_{kj} {s}_{k}^{z} ( {t}_{i - 1} ) + {c}_{i} {g}_{j} \qquad ( 8 )$$

Next, the term at prior time is taken into consideration, and Bⱼ^{z}(tᵢ) defined by Eq. (9) is computed.

Bⱼ^{z}(tᵢ)=(1−u)Bⱼ^{z0}(tᵢ)+uBⱼ^{z}(tᵢ₋₁) (9)

Herein, u is appropriately adjusted within 0≤u≤1 to make the solution accuracy high, typically u≈0.1. The effective magnetic field, including a transverse field and its schedule, is given by Eq. (10).

$${B}_{eff , j} ( {t}_{i} ) = ( ( 1 - \frac{{t}_{i}}{τ} ) γ , 0 , \frac{{t}_{i}}{τ} {B}_{j}^{z} ( {t}_{i} ) ) \qquad ( 10 )$$

When the effective magnetic field is obtained, sⱼ^{z}(t) is determined using the response function r_{b}⁰_{mod}(t) in accordance with Eq. (11).

sⱼ^{z}(tᵢ)/sⱼ^{x}(tᵢ)=r_{b mod}⁰·B_{eff,j}^{z}(tᵢ)/B_{eff,j}^{x}(tᵢ) (11)

### Sixth Embodiment

Up to the fifth embodiment, we have described the embodiments to improve the solution accuracy by adding various quantum effects, especially by adding the effect of quantum entanglement. However, the correct solution is not necessarily derived even if the above methods are used. For this reason, this embodiment will describe an auxiliary means.

Because the local-field response method is a deterministic method, the result is always the same if the same process is performed with the same initial spin values. If the initial values or the process is changed, the result may be different. Hence, we sweep the magnetic field several times while changing the initial values or the process, and we select the spin state giving the lowest energy in the process as the final solution to further improve the solution accuracy. FIG. 9 illustrates a flowchart for that case.

In FIG. 9, Processes 10a to 10d represent those described in FIG. 2 and FIGS. 4 to 8. Energy Hₚ^{q}(tₘ) (q=1, 2, . . . ) is calculated in Steps 303 using spin values sⱼ^{zfd} obtained in Processes 10a to 10d, and the lowest value E_{best} is determined in Step 304. The spin values giving the lowest energy become the final solution.

Process 10a just performs that in FIG. 2 and FIGS. 4 to 8. In Process 10b, the sign of the result sⱼ^{zfd} obtained in Process 10a is inverted, and the sign-inverted value is set as the initial value. Strictly, the initial value is sⱼ^{z}(t₀)=sⱼ^{zfd}/div using a parameter div. The reason for dividing it with div is to sufficiently reduce the initial value, and div is set to be about m. The reason for inverting the sign is that the sign-inverted state is located farthest from the uninverted state in the spin-configuration space, and that the sign inversion gives an opportunity to escape from a local minimum if a spin state is trapped there. Process 10c sets the initial spin values as 0 similarly to Process 10a. However, a factor cₐ is multiplied to a coefficient cᵢ such as cₐ·cᵢ for the coefficient of the local term gⱼ (see the third embodiment) so as to change a balance between the interaction term and the local term. The value of cₐ is empirically determined, and it is about 1 to 50. Process 10d determines the initial spin values using random numbers. Using random numbers expands possibilities of finding the solution, and the process can be simplified. Process 10d is repeatedly performed while changing the random numbers for the initial values. The solution accuracy increases as repetitions increase.

### Seventh Embodiment

This embodiment is described as an algorithm, which may be executed as a software on a general computer or on a dedicated hardware. The local-field response method in the embodiments has a feature that a relatively simple computation is repeated. Therefore, it is effective that the repeated computation part is established with a dedicated hardware, and the other parts are achieved with a general-purpose device.

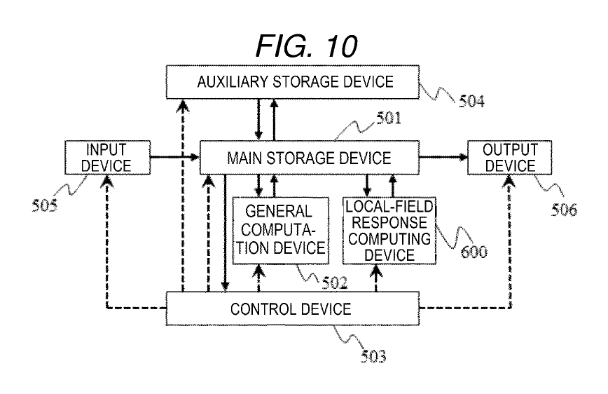

FIG. 10 illustrates an example of a configuration for the computation in this embodiment. FIG. 10 is similar to the configuration of a general computing apparatus, but it includes a local-field response computing device 600. The local-field response computing device 600 is the dedicated part for the computation described in the first to sixth embodiments. The other general computation is performed with a general computation device 502.

The above configuration may be constructed as a single computer. Alternatively, the configuration may be constructed from different computers connected through a network, where arbitrary parts such as a main storage device 501, a general computation device 502, a control device 503, an auxiliary storage device 504, an input device 505, and an output device 506 are connected to the network.

General computation is performed in the same procedure as in an ordinary computing apparatus. The main storage device 501 (storage unit) and the general computation device 502 (computing unit) repeatedly transfer data between them so as to progress the computation. At that time, the control device 503 works as a control unit. A program executed with the general computation device 502 is stored in the main storage device 501 (storage unit). When the main storage device 501 has an insufficient memory capacity, the auxiliary storage device 504 that is similarly a storage unit is used. The input device 505 is used for inputting data, a program, and the like, and the output device 506 is used for outputting results. For the input device 505, not only a manual input device such as a keyboard but also an interface for a network connection may be used. In addition, the interface serves as the output device as well.

As described in the first to sixth embodiments, N spin variables sⱼ^{z}(t) and N effective magnetic field variables B_{eff,j}^{z}(t) are iteratively determined in the local-field response computation in the embodiments. The local-field response computing device 600 dedicatedly executes this iterative computation.

In the sixth embodiment, we performed the similar Processes 10a to 10d and obtained solutions sⱼ^{zfd} for the respective processes. The obtained solutions are transferred from the local-field response computing device 600 to the main storage device 501, and the energy Hₚ^{q}(tₘ) and E_{best} are computed using the general computation device 502. That is, individual computations not belonging to the iterated computation is performed using the general computation device 502, and the dedication rate in the local-field response computing device 600 is increased.

### Eighth Embodiment

High-difficulty problems in combinatorial optimization problems belong to NP-hard. In addition, problems classified into “P” and problems classified into “NP” both can be transferred to an NP-hard problem. Therefore, if an NP-hard combinatorial optimization problem is solved, almost all the combinatorial optimization problems are solved. A ground state-searching problems described Eq. (1) include NP-hard problems. In this embodiment, we show how to treat an NP-hard problem in accordance with Eq. (1) by using a maximum cut (MAX-CUT) problem that is a representative NP-hard problem as an example.

The maximum cut problem is a problem of graph theory. In the graph theory, a graph G is constructed from an node set V and a vertex set E, and is written as G=(V, E). An edge e is written as e={i, j} using two nodes. When a graph is defined by taking the direction of edges e into consideration, the graph is called a directed graph. When a graph is defined without taking the direction into consideration, the graph is called an undirected graph. For an edge e, a weight is also defined, and it is written as wᵢⱼ and wⱼᵢ. For an undirected graph, wᵢⱼ=wⱼᵢ. Let us think of dividing nodes in a weighted undirected graph G=(V, E) into two groups. The MAX-CUT problem is to find a division method to maximize a total sum of weights of cut edges in the division problem. Let G₁=(V₁, E₁) and G₂=(V₂, E₂) be the divided two undirected graphs. Then, the MAX-CUT problem is to maximize Eq. (12).

$$w ( {V}_{1} ) = {\sum }_{i ∈ {V}_{1} , j ∈ {V}_{2}} {w}_{ij} \qquad ( 12 )$$

If sᵢ=1 is set for edge i∈V₁, and sⱼ=−1 is set for edge j∈V₂, Eq. (13) is derived.

$$w ( {V}_{1} ) = {\sum }_{i ∈ {V}_{1} , j ∈ {V}_{2}} {w}_{ij} = \frac{1}{4} {\sum }_{{i , j ∈ V}_{( i \neq j )}} {w}_{ij} {s}_{i} {s}_{j} = \frac{1}{4} {\sum }_{{i , j ∈ V}_{( i \neq j )}} {w}_{ij} - \frac{1}{2} {\sum }_{{i > j}_{( i \neq j )}} {w}_{ij} {s}_{i} {s}_{j} \qquad ( 13 )$$

Because the first term in the rightest side is a constant once a graph G is given, the MAX-CUT problem becomes a problem of minimizing Σ_{i>j}wᵢⱼsᵢsⱼ. Because the Hamiltonian of the Ising spin glass model is given by Eq. (14),

$${\hat{H}}_{p} = - {\sum }_{i > j} {J}_{ij} {\hat{σ}}_{i}^{z} {\hat{σ}}_{j}^{z} - {\sum }_{j} {g}_{j} {\hat{σ}}_{j}^{z} \qquad ( 14 )$$

the MAX-CUT problem is equivalent to the ground state-searching problem of Eq. (14) with Jᵢⱼ=−wᵢⱼ and gⱼ=0.

### Ninth Embodiment

In the second embodiment illustrated in FIG. 4, quantum entanglement is taken into consideration all over the variables at N sites corresponding to N spins in the computation. However, as the value of |sⱼ^{z}| increases, the probability with which a spin is inverted decreases. In this situation, spins may be assumed not to invert after a predetermined time, i.e., the effect of quantum entanglement may be ignored after the predetermined time. In other words, the computation at time tᵢ may be changed such that the condition of Step 113 in FIG. 4 is changed to l=x<N, and that if “Yes” at Step 113, the spins after x are not subjected to Step 112, and Steps 102a and 103 are performed individually and in parallel for all remaining sites. In this way, it is possible to shorten a process time while securing accuracy to some degree.

In this embodiment, the same function as that configured with software can be achieved with hardware such as an FPGA (Field Programmable Gate Array) and an ASIC (Application Specific Integrated Circuit).

The invention is not limited to the above embodiments, and various modifications can be made. For example, some configurations of a certain embodiment may be replaced with the configurations of another embodiment, and the configuration of the other embodiment may also be added to the configuration of a certain embodiment. In addition, part of the configurations of each embodiment may be added to or replaced with part of the configurations of other embodiments, and some of the configurations may be omitted.

What is claimed is:

1. A computing apparatus which includes a computing unit, a storage unit, and a control unit, and performs computation under the control of the control unit while transferring data between the storage unit and the computing unit, wherein
N variables sⱼ^{z} (j=1, 2, . . . , N) take a range of −1≤sⱼ^{z}≤1, and an assignment is set with coefficients gⱼ indicating local terms and coefficients Jₖⱼ (k, j=1, 2, . . . , N) indicating inter-variable interactions,
time is divided into m, and the computing unit discretely performs computation from t=t₀ (t₀=0) to tₘ (tₘ≤τ),
variables B_{eff,j}^{z}(tᵢ) and sⱼ^{z}(tᵢ) at each time tᵢ (i=1, 2, . . . , m) are determined in this order, B_{eff,j}^{z}(tᵢ) is a function of sₖ^{z} (tᵢ₋₁) Jₖⱼ, gⱼ, and tᵢ, sⱼ^{z}(tᵢ) is a function of B_{eff,j}^{z} (tᵢ) and tᵢ, and initial values at time t₀ are set as Bⱼ^{z}(t₀)=0 and sⱼ^{z}(t₀)=0,
for determining B_{eff,j}^{z}(tᵢ) and sⱼ^{z}(tᵢ) at time tᵢ (i=1, 2, . . . , m), first, sⱼ^{z}(tᵢ₋₁) are put in descending order such that |sₘ₁^{z}(tᵢ₋₁)|≤sₘ₂^{z}(tᵢ₋₁)|≤|sₘ₃^{z}(tᵢ₋₁)|≤ . . . ≤|s_{mN}^{z}(tᵢ₋₁)|, then, B_{eff,m1}^{z}(tᵢ) and sₘ₁^{z}(tᵢ) at site m₁ are determined at the first time, and sₘ₁^{z}(tᵢ₋₁) is set to be sₘ₁^{z}(tᵢ₋₁)=sgn(sₘ₁^{z}(tᵢ))|sₘ₁^{z}(tᵢ₋₁)|, next, B_{eff,m2}^{z}(tᵢ) and sₘ₂^{z}(tᵢ) at site m₂ are determined and sₘ₂^{z}(tᵢ₋₁) is set to be sₘ₂^{z}(tᵢ₋₁)=sgn(sₘ₂^{z}(tᵢ))|sₘ₂^{z}(tᵢ₋₁)|, the computation at site m₃ is performed similarly, and the computation up to site mₓ (herein, 3≤x≤N) is performed similarly for the computation at time tᵢ, and
the variable sⱼ^{z} approaches −1 or 1 as the time step progresses from t=t₀ to t=tₘ, and a solution is determined as sⱼ^{zfd}=−1 if sⱼ^{z}<0 and as sⱼ^{zfd}=1 if sⱼ^{z}>0.

2. The computing apparatus according to claim 1,
wherein B_{eff,j}^{z}(tᵢ) is determined by B_{eff,j}^{z}(tᵢ)=(tᵢ/τ)·(Σ_{k(≠j)}Jₖⱼsₖ^{z}(tᵢ₋₁)+gⱼ).

3. The computing apparatus according to claim 1, wherein
B_{eff,j}^{x}(tᵢ)=γ(1−tᵢ/τ) is set using a constant γ, θ is define by tan θ=B_{eff,j}^{z}(tᵢ)/B_{eff,j}^{x}(tᵢ), sⱼ^{z}(tᵢ) is determined by sⱼ^{z}(tᵢ)=sin θ, and thus sⱼ^{z}(tᵢ)=f(B_{eff,j}^{z}(tᵢ), tᵢ)=sin{arctan(B_{eff,j}^{z}(tᵢ)/B_{eff,j}^{x}(tᵢ))} is obtained using a function f.

4. The computing apparatus according to claim 3, wherein
correction parameters rₛ and r_{b} are added to the function f,
θ is defined by tan θ=r_{b}·B_{eff,j}^{z}(tᵢ)/B_{eff,j}^{x}(tᵢ), and sⱼ^{z}(tᵢ) is determined by sⱼ^{z}(tᵢ)=rₛ·sin θ,
and thus, the function f becomes f(B_{eff,j}^{z}(tᵢ), tᵢ)=rₛ·sin{arctan(r_{b}·B_{eff,j}^{z}(tᵢ)/B_{eff,j}^{x}(tᵢ))}.

5. The computing apparatus according to claim 2, wherein
cᵢ=(Σₖ(sₖ^{z}(tᵢ₋₁))²/N)^{1/2} and gⱼ^{norm}(tᵢ)=cᵢ·gⱼ are set, and B_{eff,j}^{z}(tᵢ) is determined by B_{eff,j}^{z}(tᵢ)=(tᵢ/τ)·(Σ_{k(≠j)}Jₖⱼsₖ(tᵢ₋₁)+gⱼ^{norm}(tᵢ)).

6. The computing apparatus according to claim 5, wherein
B_{eff,j}^{z}(tᵢ) is determined by B_{eff,j}^{z}(tᵢ)=(tᵢ/τ)·(Σ_{k(≠j)}Jₖⱼsₖ(tᵢ₋₁)+cₐ·gⱼ^{norm}(tᵢ)) using a parameter cₐ.

7. The computing apparatus according to claim 4, wherein
δr_{b}≡1−r_{b} is defined with respect to the correction parameter r_{b}, and δr_{b} is given as δr_{b}(t)∝Σ_{k(≠j)}Jₖⱼ².

8. The computing apparatus according to claim 5, wherein
Bⱼ^{z0}(tᵢ)=(Σ_{k(≠j)}Jₖⱼsₖ^{z}(tᵢ₋₁)+gⱼ^{norm}(tᵢ)) is defined, Bⱼ^{z}(tᵢ)=(1−u)Bⱼ^{z0}(tᵢ)+uBⱼ^{z}(tᵢ₋₁) is defined using a parameter u satisfying 0≤u≤1, and B_{eff,j}^{z}(tᵢ) is determined by B_{eff,j}^{z}(tᵢ)=Bⱼ^{z}(tᵢ)·tᵢ/τ.

9. The computing apparatus according to claim 1, wherein
the computation for determining sⱼ^{zfd} described in claim 1 is performed several times, a parameter div is set to a value as large as m, initial values at the second and subsequent computations are set as sⱼ^{z}(t₀)=−sⱼ^{zfd}/div using the solution sⱼ^{zfd} for the last computation or are set as sⱼ^{z}(t₀)=1/div or sⱼ^{z}(t₀)=−1/div using a random number, Hₚ=−Σ_{k>j}Jₖⱼsₖ^{zfd}(tᵢ)sⱼ^{zfd}−Σⱼgⱼsⱼ^{zfd} is calculated for each computation, and the final solution is sⱼ^{zfd} giving the minimum Hₚ in the repeated computations.

10. The computing apparatus according to claim 1, wherein
after site mₓ, the computation of time tᵢ is performed for all remaining sites independently and in parallel.

11. A computing method which uses a computing apparatus including a computing unit, a storage unit, and a control unit, and performs a computation under the control of the control unit while transferring data between the storage unit and the computing unit, wherein
N variables sⱼ^{z} (j=1, 2, . . . , N) take a range of −1≤sⱼ^{z}≤1, and an assignment is set with coefficients gⱼ indicating local terms and coefficients Jₖⱼ (k, j=1, 2, . . . , N) indicating inter-variable interactions,
time is divided into m, and the computing unit discretely performs computation from t=t₀ (t₀=0) to tₘ (tₘ≤τ),
variables B_{eff,j}^{z}(tᵢ) and sⱼ^{z}(tᵢ) at each time tᵢ (i=1, 2, . . . , m) are determined in this order,
B_{eff,j}^{z}(tᵢ) is a function of sₖ^{z}(tᵢ₋₁), Jₖⱼ, gⱼ, and tᵢ, sⱼ^{z}(tᵢ) is a function of B_{eff,j}^{z}(tᵢ) and tᵢ, and initial values at time t₀ are set as Bⱼ^{z}(t₀)=0 and sⱼ^{z}(t₀)=0,
for determining B_{eff,j}^{z}(tᵢ) and sⱼ^{z}(tᵢ) at time tᵢ (i=1, 2, . . . , m), first, sⱼ^{z}(tᵢ₋₁) are put in descending order such that |sₘ₁^{z}(tᵢ₋₁)|≤|sₘ₂^{z}(tᵢ₋₁₎|≤|sₘ₃^{z}(tᵢ₋₁₎|≤ . . . ≤|s_{mN}^{z}(tᵢ₋₁₎|,
B_{eff,m1}^{z}(tᵢ) and sₘ₁^{z}(tᵢ) at site m₁ are determined at the first time, and sₘ₁^{z}(tᵢ₋₁) is set to be sₘ₁^{z}(tᵢ₋₁)=sgn(sₘ₁^{z}(tᵢ))|sₘ₁^{z}(tᵢ₋₁)|, for the following sites, the same computation is performed up to site mₓ (herein, 1≤x≤N) for the computation at time tᵢ, and
variables sⱼ^{z} approach −1 or 1 as the time step progresses from t=t₀ to t=tₘ, and a solution is determined as sⱼ^{zfd}=−1 if sⱼ^{z}<0 and as sⱼ^{zfd}=1 if sⱼ^{z}>0.

12. The computing method according to claim 11, wherein
the same computation is performed up to site m_{N} after site m₁ for the computation at time tᵢ.

13. The computing method according to claim 11, wherein
after site mₓ, all remaining sites are processed independently and in parallel to perform the computation at time tᵢ.
